(19) United States
(12) Patent Application Publication
(10) Pub. No.: US 2014/0309329 A1
(43) Pub. Date: Oct. 16, 2014

(54) WATER-REPELLENT ANTIFOULING COATING MATERIAL

(71) Applicant: CANON KABUSHIKI KAISHA, Tokyo (JP)

(72) Inventors: Etsuko Sawada, Tokyo (JP); Satoshi Tsutsui, Yokohama-shi (JP); Yohei Hamade, Tokyo (JP); Hiroaki Mihara, Machida-shi (JP); Ken Ikegame, Ebina-shi (JP)

(73) Assignee: CANON KABUSHIKI KAISHA, Tokyo (JP)

(21) Appl. No.: 14/225,666

(22) Filed: Mar. 26, 2014

(30) Foreign Application Priority Data
Apr. 11, 2013 (JP) 2013-082769

(51) Int. Cl. C09D 5/16

(52) U.S. Cl. CPC C09D 5/1675
USPC 523/122

(57) ABSTRACT

Provided is a water-repellent antifouling coating material including a condensation product obtained by condensing hydrolyzable silane compounds. The hydrolyzable silane compounds include (a) a hydrolyzable silane compound having a perfluoropolyether group; (b) a hydrolyzable silane compound having an epoxy group; and (c) a hydrolyzable silane compound having a fluorine-containing group other than perfluoropolyether groups.

### BACKGROUND OF THE INVENTION

1. Field of the Invention

The present invention relates to a water-repellent antifouling coating material.

2. Description of the Related Art

A compound containing a perfluorooxyalkylene group (hereinafter referred to as “perfluoropolyether group”) generally has low surface free energy, and hence has water and oil repellency, releasability, antifouling property, and the like. By utilizing the properties, the perfluoropolyether-group-containing compound has been widely utilized industrially in a water-repellent and oil-repellent antifouling agent for paper, fiber, or the like, a water-repellent and oil-repellent antifouling agent for a display surface, an oil repellent for a precision instrument, or the like. As the perfluoropolyether-group-containing compound, for example, there is known a silane coupling agent having a perfluoropolyether group. When the silane coupling agent is used, in order to cause its perfluoropolyether group to closely adhere to a base material, a condensation reaction of silane can be utilized. However, the silane coupling agent cannot be considered to be sufficient in terms of an amount of a reactive group per molecule, and hence requires a long period of time for curing and is low in adhesion to the base material. Further, the silane coupling agent adheres relatively easily to a base material containing an inorganic material such as a metal, a metal oxide, or SiO₂, but does not easily react with a base material containing an organic material such as a resin plate or film.

On the other hand, as an approach to improving reactivity with a base material to obtain stronger adhesion, there is known a method involving condensing a fluorine-containing silane and a silane having a group capable of reacting with the base material to improve the reactivity with the base material. In addition, in recent years, as an approach to enabling finer processing, a method involving imparting photopolymerizability has also been disclosed. For example, Japanese Patent Translation Publication No. 2007-515498 discloses a method involving using a photocurable composition obtained by adding a photocationic polymerization initiator to a condensation product of a fluorine-containing silane and a cationically polymerizable silane.

### SUMMARY OF THE INVENTION

A water-repellent antifouling coating material according to the present invention includes a condensation product obtained by condensing hydrolyzable silane compounds, in which the hydrolyzable silane compounds include:

(a) a hydrolyzable silane compound having a perfluoropolyether group;
(b) a hydrolyzable silane compound having an epoxy group; and
(c) a hydrolyzable silane compound having a fluorine-containing group other than perfluoropolyether groups.

Further features of the present invention will become apparent from the following description of exemplary embodiments.

### DESCRIPTION OF THE EMBODIMENTS

The fluorine component of a compound having a perfluoropolyether group is liable to aggregate. Therefore, when this compound is used, aggregation may occur in a solution or in a coating film, with the result that a uniform coating film may not be obtained and unevenness may be generated on the surface. In particular, when the compound is applied onto an uncured resin as disclosed in Japanese Patent Translation Publication No. 2007-515498, a resin surface may be deformed to generate a depressed portion owing to the influence of the aggregation of the fluorine component. When the surface is uneven, the surface is liable to be fouled, and wiping of the fouling tends to be difficult. An object of the present invention is to provide a water-repellent antifouling coating that has high water repellency and high durability against abrasion, and has a smooth surface.

Water-Repellent Antifouling Coating Material

A water-repellent antifouling coating material according to the present invention includes a condensation product obtained by condensing hydrolyzable silane compounds, in which the hydrolyzable silane compounds include:

(a) a hydrolyzable silane compound having a perfluoropolyether group;
(b) a hydrolyzable silane compound having an epoxy group; and
(c) a hydrolyzable silane compound having a fluorine-containing group other than perfluoropolyether groups.

In the water-repellent antifouling coating material according to the present invention, water-repellent and antifouling functions are exhibited by the hydrolyzable silane compound (a) having a perfluoropolyether group. Its use in combination with the hydrolyzable silane compound (c) having a fluorine-containing group other than perfluoropolyether groups prevents the aggregation of the perfluoropolyether group, and thus a smooth and uniform coating film is stably obtained. Further, the use of the hydrolyzable silane compound (b) having an epoxy group in combination can enhance the durability of the coating film because the compound has an epoxy group. Hereinafter, details of the present invention are described.

Hydrolyzable Silane Compound (a) Having Perfluoropolyether Group

The perfluoropolyether group refers to a group in which one or more units containing a perfluoroalkyl group and an oxygen atom (ether bond) are connected. Specifically, the perfluoropolyether group is preferably a group represented by the following formula (5) from the viewpoints of water repellency and general-purpose property. In the following formula (5), moieties represented in parentheses are respective units, and numbers represented by o, p, q, and r, which represent the numbers of the units, are herein referred to as numbers of repeating units.

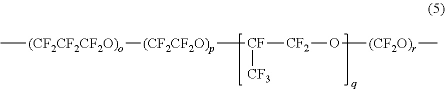

In the formula (5), o, p, q, and r each represent an integer of from 0 to 30, and at least one of o, p, q, and r represents an integer of 2 or more. o, p, q, and r each preferably represent an integer of from 1 to 30. In addition, the total of o, p, q, and r is preferably an integer of from 3 to 10 from the viewpoints of water repellency and solubility in a solvent.

The hydrolyzable silane compound (a) having a perfluoropolyether group is not particularly limited, and is preferably at least one kind of compounds represented by the following formulae (1) to (4) from the viewpoints of general-purpose property and convenience.

F-Rp-A-SiXₐY₃₋ₐ (1)

(In the formula (1), Rp represents a perfluoropolyether group, A represents an organic group having from 1 to 12 carbon atoms, X represents a hydrolyzable substituent, Y represents a non-hydrolyzable substituent, and a represents an integer of from 1 to 3.)

R₃₋ₐXₐSi-A-Rp-A-SiXₐY₃₋ₐ (2)

(In the formula (2), R represents a non-hydrolyzable substituent and may be identical to or different from Y, and Rp, A, X, Y, and a have the same meanings as in the formula (1).)

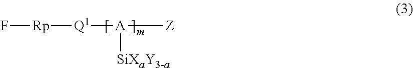

(In the formula (3), Z represents a hydrogen atom or an alkyl group, Q¹ represents a divalent linking group, m represents an integer of from 1 to 4, and Rp, A, X, Y, and a have the same meanings as in the formula (1).)

F-Rp-Q²A-SiXₐY₃₋ₐ)ₙ (4)

(In the formula (4), n represents 1 or 2, Q² represents a divalent linking group when n=1, and represents a trivalent linking group when n=2, and Rp, A, X, Y, and a have the same meanings as in the formula (1).)

In the formulae (1) to (4), Rp preferably represents a group represented by the formula (5). The number of repeating units in Rp is preferably an integer of from 1 to 30. The number of repeating units is more preferably an integer of from 3 to 20, which may vary depending on the structure of the perfluoropolyether group. The average molecular weight of Rp is preferably from 500 to 5,000, more preferably from 500 to 2,000. When the average molecular weight of Rp is 500 or more, sufficient water repellency is obtained. In addition, when the average molecular weight of Rp is 5,000 or less, sufficient solubility in a solvent is obtained. It should be noted that, in many cases, a compound having a perfluoropolyether group is by its nature a mixture of molecules having different numbers of repeating units. In addition, the average molecular weight of the perfluoropolyether group refers to an average of the total molecular weights of the moieties represented by the repeating units of the formula (5). The average molecular weight is a value measured by gel permeation chromatography (GPC).

Examples of X include a halogen atom, an alkoxy group, an amino group, and a hydrogen atom. Of those, an alkoxy group such as a methoxy group, an ethoxy group, or a propoxy group is preferred from the viewpoint that a group eliminated by a hydrolysis reaction does not inhibit a cationic polymerization reaction and the reactivity is easily controlled. Examples of Y and R include an alkyl group having from 1 to 20 carbon atoms, and a phenyl group. Examples of the alkyl group of Z include a methyl group, an ethyl group, and a propyl group. Examples of Q¹ and Q² include a carbon atom and a nitrogen atom. Examples of A include alkyl groups such as a methyl group, an ethyl group, and a propyl group. In addition, A may represent an alkyl group having a substituent.

Preferred specific examples of the hydrolyzable silane compound (a) having a perfluoropolyether group include compounds represented by the following formulae (9) to (13). One kind of those compounds may be used, or two or more kinds thereof may be used in combination.

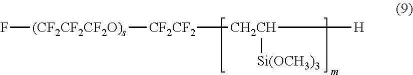

(In the formula (9), s represents an integer of from 1 to 30, and m represents an integer of from 1 to 4.)

F—(CF₂CF₂CF₂O)ₜ—CF₂CF₂—CH₂O(CH₂)₃—Si(OCH₃)₃ (10)

(In the formula (10), t represents an integer of from 1 to 30.)

(H₃CO)₃Si—CH₂CH₂CH₂—OCH₂CF₂—(OCF₂CF₂)ₐ—(OCF₂)_{f}—OCF₂CH₂O—CH₂CH₂CH₂—Si(OCH₃)₃ (11)

(In the formula (11), e and f represent an integer of from 1 to 30.)

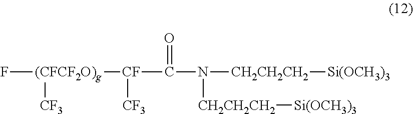

(In the formula (12), g represents an integer of from 1 to 30.)

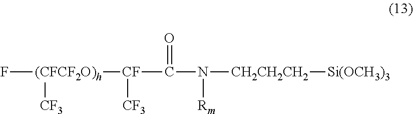

(In the formula (13), Rₘ represents a methyl group or a hydrogen atom, and h represents an integer of from 1 to 30.) In the formulae (9) to (13), the numbers of the repeating units s, t, e, f, g, and h preferably represent from 3 to 30, more preferably from 5 to 20. When s, t, e, f, g, and h represent 3 or more, water repellency improves, and when s, t, e, f, g, and h represent 30 or less, solubility in a solvent improves. Particularly when a condensation reaction is performed in a fluorine-free solvent such as an alcohol, s, t, e, f, g, and h preferably represent from 3 to 10. As commercially available products of the hydrolyzable silane compound (a) having a perfluoropolyether group, there are given, for example: “OPTOOL DSX” and “OPTOOL AES” (trade names) manufactured by DAIKIN INDUSTRIES, Ltd.; “KY-108” and “KY-164” (trade names) manufactured by Shin-Etsu Chemical Co., Ltd.; “Novec 1720” (trade name) manufactured by Sumitomo 3M Limited; and “Fluorolink S10” (trade name) manufactured by SOLVAY SPECIALTY POLYMERS JAPAN K.K. One kind of those products may be used, or two or more kinds thereof may be used in combination.

Hydrolyzable Silane Compound (b) Having Epoxy Group

The hydrolyzable silane compound (b) having an epoxy group is preferably a compound represented by the following formula (6) from the viewpoint of general-purpose property.

R_{c}—Si(R)_{b}X_{(3-b)} (6)

In the formula (6), R_{c} represents a non-hydrolyzable substituent having an epoxy group, R represents a non-hydrolyzable substituent, X represents a hydrolyzable substituent, and b represents an integer of from 0 to 2. b represents preferably 0 or 1, more preferably 0.

In the formula (6), examples of R_{c} include a glycidoxypropyl group and an epoxycyclohexylethyl group. Examples of R include an alkyl group such as a methyl group or an ethyl group, and a phenyl group. Examples of X include a halogen atom, an alkoxy group, an amino group, and a hydrogen atom. Of those, an alkoxy group such as a methoxy group, an ethoxy group, or a propoxy group is preferred from the viewpoint that a leaving group after a hydrolysis reaction does not inhibit a cationic polymerization reaction and the reactivity is easily controlled. In addition, there may be used one in which part of the group is hydrolyzed to a hydroxy group or forms a siloxane bond through dehydration condensation.

Specific examples of the compound represented by the formula (6) where X represents an alkoxy group include glycidoxypropyltrimethoxysilane, glycidoxypropyltriethoxysilane, epoxycyclohexylethyltrimethoxysilane, epoxycyclohexylethyltriethoxysilane, glycidoxypropylmethyldimethoxysilane, glycidoxypropylmethyldiethoxysilane, glycidoxypropyldimethylmethoxysilane, and glycidoxypropyldimethylethoxysilane. One kind of those compounds may be used, or two or more kinds thereof may be used in combination.

Hydrolyzable Silane Compound (c) Having Fluorine-Containing Group Other than Perfluoropolyether Group

The hydrolyzable silane compound (c) having a fluorine-containing group other than perfluoropolyether groups is not particularly limited, and is preferably a compound represented by the following formula (7) from the viewpoints of an affinity between the hydrolyzable silane compound having a perfluoropolyether group and the other components, and the prevention of the aggregation of the perfluoropolyether group.

(R_{f})ₐ—Si(R)_{b}X_{(4-a-b)} (7)

In the formula (7), R_{f} represents an alkyl group or aryl group having 1 or more fluorine atoms, R represents a non-hydrolyzable substituent, X represents a hydrolyzable substituent, a represents an integer of 1 or 2, b represents an integer of from 0 to 2, and a+b is an integer of from 1 to 3.

In the formula (7), R_{f} represents preferably an alkyl group or aryl group having from 1 to 10 fluorine atoms, more preferably an alkyl group or aryl group having from 3 to 5 fluorine atoms. The incorporation of the fluorine atom prevents the separation of the perfluoropolyether group from the other components, and prevents the aggregation of the perfluoropolyether group. On the other hand, when the number of fluorine atoms becomes large, the compound may aggregate by itself, with the result that a preventive effect on the aggregation of the perfluoropolyether group may lower. A specific example of R_{f} is a group in which part or all of hydrogen atoms of a methyl group, an ethyl group, an n-propyl group, an isopropyl group, an n-butyl group, a sec-butyl group, an isobutyl group, a tert-butyl group, a phenyl group, a naphthyl group, or the like are substituted with fluorine atoms. R_{f} preferably represents a 3,3,3-trifluoropropyl group, a pentafluorophenyl group, a perfluorobutyl group, or a trifluoromethyl group from the viewpoint that such compound is commercially available and easily available.

In the formula (7), examples of R include an alkyl group such as a methyl group, an ethyl group, or a propyl group and an aryl group such as a phenyl group. Examples of X include a halogen atom and an alkoxy group such as a methoxy group, an ethoxy group, or a propoxy group. Specific examples of the compound represented by the formula (7) include 3,3,3-trifluoropropyltrimethoxysilane, nonafluoro-1,1,2,2-tetrahydrohexyltriethoxysilane, tridecafluoro-1,1,2,2-tetrahydrooctyltriethoxysilane, and pentafluorophenyltriethoxysilane. One kind of those compounds may be used, or two or more kinds thereof may be used in combination.

The molar ratio (a):(c) of the hydrolyzable silane compound (a) having a perfluoropolyether group to the hydrolyzable silane compound (c) having a fluorine-containing group other than perfluoropolyether groups is preferably from 1:4 to 1:50. The ratio (a):(c) is more preferably from 1:10 to 1:40, still more preferably from 1:15 to 1:30. When the ratio (a):(c) is 1:4 or more, the aggregation of the perfluoropolyether group can be sufficiently prevented, and the generation of unevenness or a development residue in the surface of a water-repellent antifouling coating can be suppressed. In addition, the hydrolyzable silane compound (c) having a fluorine-containing group other than perfluoropolyether groups itself does not exhibit water-repellent, oil-repellent, and antifouling functions in many cases, and hence, when the ratio (a):(c) is 1:50 or less, the water-repellent and antifouling functions can be prevented from lowering.

Hydrolyzable Silane Compound (d) Having Alkyl Group or Aryl Group

The hydrolyzable silane compounds preferably further include, in addition to (a), (b), and (c), a hydrolyzable silane compound (d) having an alkyl group or an aryl group represented by the following formula (8).

(R_{d})ₐ—SiX₍₄₋ₐ₎ (8)

In the formula (8), R_{d} represents an alkyl group or an aryl group, X represents a hydrolyzable substituent, a represents an integer of from 1 to 3. It should be noted that when a represents 2 or 3 and multiple R_{d}'s are present, R_{d}'s may be identical to or different from each other. Examples of R_{d} include a methyl group, an ethyl group, a propyl group, a butyl group, a hexyl group, a phenyl group, and a naphthyl group. Of those, at least one of a methyl group and a phenyl group is preferred from the viewpoint of water repellency. Examples of X include a halogen atom and an alkoxy group such as a methoxy group, an ethoxy group, or a propoxy group. Specific examples of the compound represented by the formula (8) include methyltrimethoxysilane, methyltriethoxysilane, methyltripropoxysilane, ethyltrimethoxysilane, ethyltriethoxysilane, ethyltripropoxysilane, propyltrimethoxysilane, propyltriethoxysilane, propyltripropoxysilane, dimethyldimethoxysilane, dimethyldiethoxysilane, phenyltrimethoxysilane, phenyltriethoxysilane, trimethylmethoxysilane, and trimethylethoxysilane. One kind of those compounds may be used, or two or more kinds thereof may be used in combination.

Through the use of the hydrolyzable silane compound (d) having an alkyl group or an aryl group represented by the formula (8) in combination, the polarity and crosslinking density of the condensation product can be controlled. When such silane compound, which is not cationically polymerizable, is used in combination, the degree of freedom of a substituent improves to promote, for example, the orientation of the perfluoropolyether group on the air interface side, the polymerization of the epoxy group, and the condensation of an unreacted silanol group. In addition, the presence of a non-polar group such as an alkyl group suppresses the cleavage of a siloxane bond to improve water repellency and durability.

The mixing proportion of each of the hydrolyzable silane compounds to be used for the preparation of the condensation product according to the present invention is appropriately determined depending on usage forms thereof. However, the mixing proportion of the hydrolyzable silane compound (a) having a perfluoropolyether group is preferably from 0.01 to 5 mol % when the total number of moles of the hydrolyzable silane compounds to be used is taken as 100 mol %. The mixing proportion is more preferably from 0.1 to 4 mol %. When the mixing proportion is 0.01 mol % or more, sufficient water repellency is obtained. In addition, when the mixing proportion is 5 mol % or less, the occurrence of the aggregation and precipitation of the hydrolyzable silane compound having a perfluoropolyether group is suppressed, and a uniform coating solution or coating film is obtained. The mixing proportion of the hydrolyzable silane compound (c) having a fluorine-containing group other than perfluoropolyether groups is preferably from 1 to 50 mol % when the total number of moles of the hydrolyzable silane compounds to be used is taken as 100 mol % from the viewpoints of the prevention of the aggregation of the perfluoropolyether group and water repellency. The mixing proportion is more preferably from 5 to 40 mol %, which may vary depending on the mixing amount of the (a) as described above.

The mixing proportion of the hydrolyzable silane compound (b) having an epoxy group is preferably from 30 to 70 mol % when the total number of moles of the hydrolyzable silane compounds to be used is taken as 100 mol % from the viewpoint of obtaining adhesive property with respect to an undercoat and the durability of a water-repellent layer. The mixing proportion is more preferably from 40 to 55 mol %. When the mixing proportion is 30 mol % or more, sufficient durability of a coating film is obtained. In addition, when the mixing proportion is 70 mol % or less, lowering of water repellency due to the polarity of the epoxy group can be suppressed. The mixing proportion of the hydrolyzable silane compound (d) having an alkyl group or an aryl group represented by the formula (8) is preferably from 5 to 70 mol % when the total number of moles of the hydrolyzable silane compounds to be used is taken as 100 mol % from the viewpoint of water repellency. The mixing proportion is more preferably from 10 to 50 mol %.

In the present invention, each of the hydrolyzable silane compounds is not used alone, but the hydrolyzable silane compounds are condensed to be used as a condensation product. Thus, film formation property at the time of application is satisfactory and a smooth coating film is stably obtained. Further, when the material according to the present invention is applied onto a photopolymerizable resin layer and collectively cured together with the photopolymerizable resin layer, durability can be enhanced, and the use as a condensation product allows the control of compatibility with the resin layer and of patterning characteristics. It should be noted that, when the silane compounds that are not condensed are directly applied, a desired composition may not be obtained owing to the volatilization of part of the components, or the shape of the photopolymerizable resin layer serving as an undercoat may be lost. This condensation reaction can be performed by allowing a hydrolysis and condensation reaction to proceed under heating in a solvent in the presence of water. A desired condensation degree can be obtained by appropriately controlling the hydrolysis and condensation reaction in terms of temperature, time, concentration, pH, and the like.

In this case, the degree of progress of the condensation reaction (condensation degree) can be defined by a ratio of the number of condensed functional groups with respect to the number of condensable functional groups. The condensable functional groups correspond to the above-mentioned hydrolyzable substituents. The condensation degree can be estimated by ²⁹Si-NMR measurement. For example, in the case of using a hydrolyzable silane compound having three hydrolyzable substituents in one molecule, the following four peaks can be isolated. The condensation degree is calculated according to the following equation from the peak integration values.

T0 form: Si atom not bonded to any other hydrolyzable silane compound

T1 form: Si atom bonded to one hydrolyzable silane compound via oxygen

T2 form: Si atom bonded to two hydrolyzable silane compounds via oxygen

T3 form: Si atom bonded to three hydrolyzable silane compounds via oxygen

$$Condensation degree = \frac{( T 1 + 2 * T 2 + 3 * T 3 ) * 100}{3 * ( T 0 + T 1 + T 2 + T 3 )}$$

The condensation degree, which also varies depending on the kinds of the hydrolyzable silane compounds to be used and synthesis conditions, is preferably 40% or more, more preferably 50% or more from the viewpoints of compatibility with a resin and application property. In addition, the condensation degree is preferably 90% or less, more preferably 70% or less from the viewpoint of preventing precipitation, gelation, and the like. In this regard, however, it is rare that the condensation degree is more than 90% in a state in which the compounds are dissolved in a solution.

In addition, when the proportion of an unreacted silane (T0 form) is high, the uniformity of the coating film lowers in some cases, and hence the proportion of the T0 form (ratio of an Si atom not bonded to any other hydrolyzable silane compound to all Si atoms) is preferably 20% or less. The proportion is more preferably from 1 to 10%. In addition, when the ratio of a silane compound in which all hydrolyzable substituents are condensed increases, water-repellent and antifouling properties lower and a gel precipitates in a solution in some cases. For example, in a silane converted to a T3 form in a solution, the degree of freedom of a substituent lowers, and the surface orientation of fluorine in a coating film to be obtained is disturbed in some cases, with the result that water-repellent and antifouling properties lower in some cases. Therefore, the proportion of the T3 form (ratio of an Si atom bonded to three hydrolyzable silane compounds via oxygen to all Si atoms) is preferably 50% or less. The proportion is more preferably from 10 to 40%.

In addition, also in the case of a hydrolyzable silane compound having two hydrolyzable substituents in one molecule, the condensation degree can be calculated according to the following equation.

D0 form: Si atom not bonded to any other hydrolyzable silane compound

D1 form: Si atom bonded to one hydrolyzable silane compound via oxygen

D2 form: Si atom bonded to two hydrolyzable silane compounds via oxygen

$$Condensation degree = \frac{( D 1 + 2 * D 2 ) * 100}{2 * ( D 0 + D 1 + D 2 )}$$

In addition, in the hydrolysis and condensation reaction, a metal alkoxide, an acid, an alkali, or the like may be utilized as a catalyst to control the condensation degree. Examples of the metal alkoxide include an aluminum alkoxide, a titanium alkoxide, a zirconia alkoxide, and complexes (e.g., an acetylacetone complex) thereof. One kind of those metal alkoxides may be used, or two or more kinds thereof may be used in combination. It is also useful to adjust the pH with an acid or an alkali. However, when an alkali catalyst is used, solid matter such as a gel precipitates in a solution in some cases, and hence an acid catalyst is preferred. That is, it is preferred to subject the hydrolyzable silane compounds to a reaction using an acid as a catalyst in the presence of an organic solvent and water. In this regard, however, when an inorganic strong acid such as hydrochloric acid or sulfuric acid remains, the remaining acid affects the surrounding members such as a base material in some cases. In addition, when the pH is too low, the epoxy group in the condensation product may undergo ring-opening to lower coating film characteristics. Therefore, an acid that is a weak acid and has a low molecular weight and has volatility is preferred. Specific examples thereof include carboxylic acids such as acetic acid, glycolic acid, and formic acid. One kind of those acids may be used, or two or more kinds thereof may be used in combination. It should be noted that those organic acids are added at the time of the reaction, but are often contained in trace amounts in hydrolyzable silane compounds as raw materials. Accordingly, it is not necessary to separately add the acids.

In the present invention, the multiple hydrolyzable silane compounds are used in combination, and hence when the rate of a hydrolysis and condensation reaction significantly differs depending on the kinds of the hydrolyzable silane compounds, a compound having a low reaction rate remains unreacted in some cases while the condensation reaction of a compound having a high reaction rate proceeds. In those cases, the uniformity and water repellency of the coating film may lower. Therefore, it is preferred to use a catalyst such as an acid from the viewpoint of allowing each of the hydrolyzable silane compounds to react uniformly as much as possible.

The condensation product may be synthesized in a solvent having a hydroxy group, a carbonyl group, an ether bond, or the like. Specific examples thereof include fluorine-free organic solvents such as: alcohols such as methanol, ethanol, propanol, isopropanol, and butanol; ketones such as methyl ethyl ketone and methyl isobutyl ketone; esters such as ethyl acetate and butyl acetate; ethers such as diglyme and tetrahydrofuran; and glycols such as diethylene glycol. One kind of those solvents may be used, or two or more kinds thereof may be used in combination. In addition, an alcohol having high solubility in water is preferred because water is used for the synthesis. In addition, heating at the time of the reaction is preferably performed at 100° C. or less from the viewpoint of controlling the amount of water. Accordingly, when the reaction is performed under heating to reflux, it is preferred to use an organic solvent having a boiling point of from 50 to 100° C.

A fluorine-free organic solvent such as an alcohol is generally used for the hydrolysis and condensation reaction of a hydrolyzable silane compound. However, the hydrolyzable silane compound (a) having a perfluoropolyether group has low solubility in the fluorine-free organic solvent. The inventors of the present invention have found that a uniform condensation product can be synthesized by heating the hydrolyzable silane compounds in a mixed liquid of a fluorine-free organic solvent and a fluorine-containing solvent. Further, the length of the perfluoropolyether group is preferably made suitable so as to fall within the above-mentioned range. Examples of the fluorine-containing solvent include a hydrofluorocarbon, a perfluorocarbon, a hydrofluoroether, a hydrofluoropolyether, and a perfluoropolyether. Of those, a hydrofluoroether, a hydrofluoropolyether, or a perfluoropolyether, which has an oxygen atom and is compatible with water, is preferred because the addition of water is required for hydrolysis. One kind of those fluorine-containing solvents may be used, or two or more kinds thereof may be used in combination. The combination of the fluorine-free organic solvent and the fluorine-containing solvent is not particularly limited, and a combination of an alcohol and a hydrofluoroether is preferred from the viewpoints of solubility and the uniform synthesis of the condensation product. The mixing ratio (volume ratio) of the fluorine-free organic solvent to the fluorine-containing solvent is preferably from 2:8 to 9:1, more preferably from 3:7 to 8:2.

When the hydrolyzable substituent of a hydrolyzable silane compound is an alkoxy group, an alcohol and water are produced through a hydrolysis and condensation reaction. Therefore, it is difficult to calculate the concentration of a component in an actual solution. Therefore, a value calculated on the assumption of a state in which all alkoxy groups are hydrolyzed and all silanol groups are condensed, i.e., a state in which the condensation degree is 100%, is herein defined as effective component concentration. The effective component concentration in the reaction solution is preferably 10 mass % or more and 50 mass % or less, more preferably 15 mass % or more and 40 mass % or less. When the effective component concentration is 10 mass % or more, a sufficient reaction rate is obtained. When the effective component concentration is 50 mass % or less, the occurrence of gelation and precipitation can be suppressed. It should be noted that the effective component concentration is calculated on the assumption that all hydrolyzable substituents are eliminated, and hence the effective component concentration has a lower value than the concentration of the silane compounds calculated from the feed amounts of the solvent (alcohol, water, etc.) and hydrolyzable silane compounds actually used for the synthesis. The concentration of the silane compounds calculated from the feed amounts is preferably 20 mass % or more and 90 mass % or less.

The amount of water to be used for the reaction is preferably from 0.5 to 3 equivalents, more preferably from 0.8 to 2 equivalents with respect to the hydrolyzable substituents of the hydrolyzable silane compounds. When the amount of water is 0.5 equivalent or more, a sufficient reaction rate in the hydrolysis and condensation reaction is obtained. When the amount of water is 3 equivalents or less, the precipitation of the hydrolyzable silane compound having a perfluoropolyether group can be suppressed.

Water-Repellent Antifouling Coating

A water-repellent antifouling coating according to the present invention is obtained using the water-repellent antifouling coating material according to the present invention through the curing of the condensation product contained in the water-repellent antifouling coating material with a photopolymerization initiator.

The photopolymerization initiator is used in order to cure the condensation product having an epoxy group and a silanol group through photoirradiation. As the photopolymerization initiator, there may be used photoacid generators such as: an onium salt compound such as a sulfonium salt or an iodonium salt; a sulfonic acid compound; and a diazomethane compound. As commercially available products of the photopolymerization initiator, there are given, for example: “ADEKA OPTOMER SP-170”, “ADEKA OPTOMER SP-172”, and “SP-150” (trade names) manufactured by ADEKA CORPORATION; “BBI-103” and “BBI-102” (trade names) manufactured by Midori Kagaku Co., Ltd.; and “IBPF”, “IBCF”, “TS-01”, and “TS-91” (trade names) manufactured by SANWA CHEMICAL CO., LTD. One kind of those photopolymerization initiators may be used, or two or more kinds thereof may be used in combination. The use of the photoacid generator as the photopolymerization initiator is preferred because, in this case, the dehydration condensation reaction of not only the epoxy group but also the silanol group is promoted by an acid. It should be noted that a light absorber, a sensitizer, or the like may be used to improve patterning characteristics. A coating liquid for the water-repellent antifouling coating can be prepared by adding such photopolymerization initiator to the water-repellent antifouling coating material. In addition, when an undercoat for a coating film of the coating liquid for the water-repellent antifouling coating contains a photoacid generator, an acid diffuses from the undercoat, and hence the coating film can be cured without adding a photoacid generator to the water-repellent antifouling coating material according to the present invention.

The coating film of the coating liquid for the water-repellent antifouling coating may be produced by, for example, using an application apparatus to apply the coating liquid prepared by dissolving the water-repellent antifouling coating material according to the present invention and the photopolymerization initiator in an appropriate solvent. As the application apparatus, there may be used a generally used apparatus such as a spin coater, a die coater, a slit coater, or a spray coater. In addition, dip coating can also be applied by adjusting the concentration of the water-repellent antifouling coating material. The concentration of the condensation product in the coating liquid is appropriately determined depending on the composition of the condensation product, application method, and intended use. However, the concentration of the condensation product in the coating liquid is preferably from 0.1 to 20 mass %, more preferably from 1 to 15 mass % in terms of the above-mentioned effective component concentration. When the concentration of the condensation product falls within that range, sufficient water repellency and durability are obtained, and water repellency that is uniform throughout the entire coating film surface is obtained. The thickness of the coating film is preferably from 50 to 10,000 nm, more preferably from 80 to 5,000 nm. When the film thickness is 50 nm or more, uniform water repellency and sufficient durability are obtained. In addition, when the film thickness is 10,000 nm or less, the deformation of a pattern and the lowering of patterning characteristics such as the lowering of resolution property can be suppressed.

After the production of the coating film on a base material by an arbitrary method, photoirradiation is performed, and as required, curing by light or heat is performed, to thereby cure the coating film. According to the configuration of the present invention, even a thin film can exhibit high durability because of the curing reaction of the coating film using cationic polymerization of an epoxy group in combination with condensation polymerization of a silane (silanol group) by heat.

In addition, when pattern exposure is performed at the time of the photoirradiation, surface treatment of a fine region can be performed with the water-repellent antifouling coating according to the present invention. When the pattern exposure is performed, after the process of development treatment or the like, more intense photoirradiation or curing by heating may be performed. A coating film having high durability is obtained by performing appropriate curing treatment to completely cure an unreacted group. At this time, for the purposes of improving patterning characteristics such as sensitivity and resolution property and improving durability, an epoxy compound other than hydrolyzable silane compounds is preferably added to the water-repellent antifouling coating material. The water-repellent antifouling coating material according to the present invention realizes high durability by using the polymerization reaction of an epoxy group in combination with the condensation reaction of a silanol group, and the incorporation of the epoxy compound allows the control of coating film physical properties and can enhance the durability. In addition, the incorporation of the epoxy compound increases the viscosity of the coating liquid, which allows the film thickness to be increased.

Examples of the epoxy compound other than hydrolyzable silane compounds include a bisphenol A-type epoxy resin and a novolac-type epoxy resin. As commercially available products of the epoxy compound, there are given, for example: “CELLOXIDE 2021”, “GT-300 series”, “GT-400 series”, and “EHPE3150” (trade names) manufactured by Daicel Corporation; “157S70” (trade name) manufactured by Japan Epoxy Resin Corporation; “Epiclon N-865” (trade name) manufactured by DIC Corporation; and “SU8” manufactured by NIPPON KAYAKU Co., Ltd. One kind of those products may be used, or two or more kinds thereof may be used in combination. The epoxy equivalent of the epoxy compound is preferably 2,000 or less, more preferably 1,000 or less. When the epoxy equivalent is 2,000 or less, a sufficient crosslinking density is obtained in a curing reaction, the glass transition temperature of a cured product does not lower, and high adhesiveness is obtained. The epoxy equivalent of the epoxy compound is preferably 50 or more. It should be noted that the epoxy equivalent is a value measured according to JIS K-7236. In addition, in the case of forming a pattern using the coating material of the present invention, if the material has high fluidity, resolution property may lower. Therefore, the epoxy compound is preferably a compound that is solid at 35° C. or less. In addition to the above-mentioned materials, for example, “SU-8 series” and “KMPR-1000” (trade names) manufactured by Kayaku Micro Chem Corporation, and “TMMR S2000” and “TMMF 32000” (trade names) manufactured by TOKYO OHKA KOGYO CO., LTD., which are commercially available as negative resists, may be used as the epoxy compound.

The condensation product according to the present invention is a material excellent in compatibility with the epoxy compound. Therefore, as with the above-mentioned photopolymerization initiator, the epoxy compound may be added to the water-repellent antifouling coating material according to the present invention, or may be used as an undercoat. Also in the case of using the epoxy compound as an undercoat, a similar effect to that in the case of directly adding the epoxy compound to the water-repellent antifouling coating material can be obtained due to compatibility with the undercoat.

The water-repellent antifouling coating according to the present invention can be utilized as, for example, a water-repellent antifouling coating for a fine pattern in the fields of advanced devices such as a semiconductor device, a display panel, and an ink jet head.

Manufacturing Method for Water-Repellent Antifouling Coating

A manufacturing method for a water-repellent antifouling coating according to the present invention includes the steps of:

applying, on a substrate, a water-repellent antifouling coating material containing a condensation product obtained by condensing hydrolyzable silane compounds, a photoacid generator, and an epoxy compound other than hydrolyzable silane compounds; and
subjecting a coating film of the water-repellent antifouling coating material to exposure and heat treatment to cure the coating film,
in which the hydrolyzable silane compounds include:
(a) a hydrolyzable silane compound having a perfluoropolyether group;
(b) a hydrolyzable silane compound having an epoxy group; and
(c) a hydrolyzable silane compound having a fluorine-containing group other than perfluoropolyether groups. According to the method, by virtue of the condition that the water-repellent antifouling coating material contains the photoacid generator and the epoxy compound other than hydrolyzable silane compounds, the water-repellent antifouling coating obtained by curing the material exhibits high water repellency, antifouling property, durability, and smoothness.

In addition, another manufacturing method for a water-repellent antifouling coating according to the present invention includes the steps of:

(1) forming a photopolymerizable resin layer on a substrate using a photopolymerizable resin containing an epoxy compound other than hydrolyzable silane compounds and a photopolymerization initiator;
(2) forming a water-repellent antifouling layer on the photopolymerizable resin layer using the water-repellent antifouling coating material according to the present invention;
(3) simultaneously exposing the photopolymerizable resin layer and the water-repellent antifouling layer; and
(4) collectively curing an exposed portion of the photopolymerizable resin layer and the water-repellent antifouling layer. According to this method, the photopolymerizable resin layer serving as an undercoat contains the epoxy compound other than hydrolyzable silane compounds and the photopolymerization initiator, and the water-repellent antifouling layer formed thereon and the photopolymerizable resin layer partially dissolve into each other. Accordingly, as in the method described above, the water-repellent antifouling coating to be obtained exhibits high water repellency, antifouling property, durability, and smoothness. The method may further include the step of
(5) removing a non-exposed portion of the photopolymerizable resin layer and the water-repellent antifouling layer to form a pattern.

### EXAMPLES

Examples and Comparative Examples are shown below. However, the present invention is not limited thereto. Various measurements and evaluations were performed by methods shown below.

Condensation Degree

The condensation degree of a prepared condensation product was calculated based on the above-mentioned definition by performing ²⁹Si-NMR measurement through use of a nuclear magnetic resonance apparatus (product name: AVANCE II 500 MHz, manufactured by Bruker BioSpin Co.). In addition, based on peak intensities, the amount of an unreacted monomer (T0 amount) and the amount of a product in which all hydrolyzable substituents are condensed (T3 amount) were also calculated.

Coating Film External Appearance

A coating film was observed for a development residue and a surface condition with a scanning electron microscope (product name: S-4300, manufactured by Hitachi High-Technologies Corporation). The external appearance of the coating film was evaluated by the following criteria.

Development Residue

A: No development residue is found.

B: A fine development residue having a size of 0.3 μm or less is found.

C: A development residue having a size of more than 0.3 μm is found.

Surface Condition

A: The surface is smooth.

B: Fine unevenness having a size of 0.3 μm or less is found on the surface.

C: Unevenness having a size of more than 0.3 μm is found on the surface.

Pure Water Contact Angle

As an evaluation of a produced coating film, a dynamic retreat contact angle θr with pure water was measured through use of a micro contact angle meter (product name: Drop Measure, manufactured by MICROJET Corporation), and initial water repellency was evaluated. In addition, as an evaluation of the durability of a coating film surface, the coating film was immersed in an alkaline aqueous solution having a pH of 10, kept at 60° C. for 1 week, and washed with water, and then θr with pure water was measured. Further, as an evaluation of the durability against abrasion, a wiping operation using a blade made of hydrogenated nitrile-butadiene rubber (HNBR) was carried out 2,000 times while an aqueous solution containing carbon black was sprayed onto the coating film, and then θr with pure water was measured.

### Example 1

A condensation product was prepared by the following method. 0.96 g of the compound represented by the formula (12) (0.726 mmol, g represents an integer of from 3 to 10, hereinafter referred to as compound (i)), 12.53 g of γ-glycidoxypropyltriethoxysilane (0.045 mol, hereinafter referred to as GPTES), 4.91 g of 3,3,3-trifluoropropyltrimethoxysilane (0.0225 mol, hereinafter referred to as C1), 8.02 g of methyltriethoxysilane (0.0225 mol, hereinafter referred to as MTEOS), 5.93 g of pure water, 15.15 g of ethanol, and 3.83 g of a hydrofluoroether (trade name: HFE 7200, manufactured by Sumitomo 3M Limited) were stirred at room temperature for 5 minutes in a flask equipped with a cooling pipe. After that, the mixture was heated to reflux for 24 hours to prepare a condensation product. In this case, the condensation degree was 70%, the T0 amount was 3.5%, and the T3 amount was 36%. The solution of the condensation product was diluted 4-fold with ethanol to prepare a water-repellent antifouling coating material.

Next, 100 parts by mass of an epoxy compound (trade name: EHPE-3150, manufactured by Daicel Corporation) and 6 parts by mass of a photoacid generator (trade name: SP-172, manufactured by ADEKA CORPORATION) were dissolved in 80 parts by mass of xylene serving as a solvent to afford a photopolymerizable resin composition. The photopolymerizable resin composition was applied onto a substrate by a spin coating method so that the film thickness was 10 μm, followed by heat treatment at 90° C. for 5 minutes to form a photopolymerizable resin layer. The above-mentioned water-repellent antifouling coating material was applied onto the photopolymerizable resin layer using a slit coater, followed by heat treatment at 90° C. The thickness of the coating film of the water-repellent antifouling coating material was adjusted so as to correspond to a thickness after the heat treatment of about 0.5 μm. It should be noted that the coating film and the photopolymerizable resin layer serving as an undercoat mutually dissolved and their interface was not able to be seen, and hence the film thickness on the photopolymerizable resin layer was not able to be measured.

Next, the photopolymerizable resin layer and water-repellent antifouling coating material on the substrate were irradiated with the i-line via a mask having a pattern for evaluation. After that, heat treatment was performed at 90° C. for 4 minutes. Development treatment was performed with a mixed liquid of methyl isobutyl ketone (MIBK) and xylene, and then rinsing treatment was performed with isopropanol to form a desired pattern. The coating film was further heated at 200° C. for 1 hour to be cured. Thus, a water-repellent antifouling coating was obtained. Table 1 shows the results. The photopolymerizable resin layer having the water-repellent antifouling coating formed thereon had a smooth external appearance, and the water-repellent antifouling coating exhibited high values of the pure water contact angles at the initial stage and after the durability test.

### Example 2

To 100 parts by mass of the water-repellent antifouling coating material prepared in Example 1, was added 0.4 part by mass of a photoacid generator (trade name: SP-172, manufactured by ADEKA CORPORATION) to prepare a water-repellent antifouling coating material. The water-repellent antifouling coating material was applied onto a substrate by a spin coating method, followed by heat treatment at 90° C. to afford a coating film having a thickness of 0.5 μm. In the same manner as in Example 1, i-line irradiation, development treatment, and heat treatment were performed to afford a water-repellent antifouling coating. Table 1 shows the results. As in Example 1, the water-repellent antifouling coating had a smooth surface, and exhibited high values of the pure water contact angles at the initial stage and after the durability test.

### Example 3

To 100 parts by mass of the water-repellent antifouling coating material prepared in Example 1, were added 0.8 part by mass of a photoacid generator (trade name: SP-172, manufactured by ADEKA CORPORATION) and 7 parts by mass of an epoxy compound (trade name: EHPE-3150, manufactured by Daicel Corporation). Further, the mixture was diluted with an ethanol/butanol mixed solvent to prepare a water-repellent antifouling coating material. Treatment was performed in the same manner as in Example 2 using the water-repellent antifouling coating material to afford a water-repellent antifouling coating. Table 1 shows the results. Also in the case of adding the epoxy compound and the photoacid generator to the water-repellent antifouling coating material, as in Example 1, the water-repellent antifouling coating had a smooth surface, and exhibited high values of the pure water contact angles at the initial stage and after the durability test.

### Example 4

A condensation product was synthesized in the same manner as in Example 1 except that MTEOS was changed to phenyltriethoxysilane (hereinafter referred to as PhTES), and the condensation product was diluted with an ethanol/butanol mixed solvent to prepare a water-repellent antifouling coating material. Further, a water-repellent antifouling coating was obtained by the same procedure as that of Example 1. Table 1 shows the results. As in Example 1, the water-repellent antifouling coating had a smooth surface, and exhibited high values of the pure water contact angles at the initial stage and after the durability test.

### Examples 5 to 7

In Example 5, the mixing amounts of GPTES and C1 were changed to values shown in Table 1. In Example 6, the mixing amount of C1 was changed to a value shown in Table 1, and MTEOS was not added. In Example 7, the mixing amounts of the compound (i) and C1 were changed to values shown in Table 1, and MTEOS was not added. Condensation products were synthesized in the same manner as in Example 1 except for these changes. The condensation products were diluted with an ethanol/butanol mixed solvent to prepare water-repellent antifouling coating materials. Further, water-repellent antifouling coatings were obtained by the same procedure as that of Example 1. Table 1 shows the results. Owing to the small mixing amount of GPTES and the large mixing amount of C1, the water repellency showed a tendency to lower slightly. However, the surface conditions of the water-repellent antifouling coatings were satisfactory.

### Example 8

A condensation product was synthesized in the same manner as in Example 1 except that the mixing amount of each hydrolyzable silane compound was changed to a value shown in Table 1, and the condensation product was diluted with an ethanol/butanol mixed solvent to prepare a water-repellent antifouling coating material. Further, a water-repellent antifouling coating was obtained by the same procedure as that of Example 1. Table 1 shows the results. Owing to the relatively small mixing amount of C1, a slight amount of a development residue was found on the surface of the water-repellent antifouling coating.

### Example 9

A condensation product was synthesized in the same manner as in Example 1 except that a bifunctional hydrolyzable silane compound γ-glycidoxypropylmethyldiethoxysilane (hereinafter referred to as GPMDES) was used in place of GPTES. The condensation product was diluted with an ethanol/butanol mixed solvent to prepare a water-repellent antifouling coating material. Further, a water-repellent antifouling coating was obtained by the same procedure as that of Example 1. Table 1 shows the results. As in Example 1, the water-repellent antifouling coating had a smooth surface, and exhibited high values of the pure water contact angles at the initial stage and after the durability test.

### Examples 10 and 11

Condensation products were synthesized by the same method as that of Example 1 except that organic acid aqueous solutions shown in Table 1 were used in place of pure water, and the condensation products were diluted with an ethanol/butanol mixed solvent to prepare water-repellent antifouling coating materials. Further, water-repellent antifouling coatings were obtained by the same procedure as that of Example 1. Table 1 shows the results. It was found that the T3 proportion was slightly reduced as compared to the case of using pure water. In addition, as in Example 1, the water-repellent antifouling coatings had a smooth surface, and exhibited high values of the pure water contact angles at the initial stage and after the durability test.

### Example 12

A condensation product was synthesized by the same method as that of Example 1 except that tridecafluoro-1,1,2,2-tetrahydrooctyltriethoxysilane (number of fluorine atoms: 13, hereinafter referred to as C6) was used in place of C1 and the composition was changed as shown in Table 1. The condensation product was diluted with an ethanol/butanol mixed solvent to prepare a water-repellent antifouling coating material. Further, a water-repellent antifouling coating was obtained by the same procedure as that of Example 1. Table 1 shows the results. A slightly depressed portion was generated on the surface of the water-repellent antifouling coating. However, no development residue was generated, and the water repellency was satisfactory.

### Example 13

A condensation product was synthesized by the same method as that of Example 1 except that nonafluoro-1,1,2,2-tetrahydrohexyltriethoxysilane (number of fluorine atoms: 9, hereinafter referred to as C4) was used in place of C1 and the composition was changed as shown in Table 1. The condensation product was diluted with an ethanol/butanol mixed solvent to prepare a water-repellent antifouling coating material. Further, a water-repellent antifouling coating was obtained by the same procedure as that of Example 1. Table 1 shows the results. As in Example 1, the water-repellent antifouling coating had a smooth surface on which no residue was found, and exhibited high values of the pure water contact angles at the initial stage and after the durability test.

### Example 14

A condensation product was synthesized by the same method as that of Example 1 except that pentafluorophenyltriethoxysilane (number of fluorine atoms: 5, hereinafter referred to as F5Ph) was used in place of C1 and the composition was changed as shown in Table 1. The condensation product was diluted with an ethanol/butanol mixed solvent to prepare a water-repellent antifouling coating material. Further, a water-repellent antifouling coating was obtained by the same procedure as that of Example 1. Table 1 shows the results. As in Example 1, the water-repellent antifouling coating had a smooth surface on which no residue was found, and exhibited high values of the pure water contact angles at the initial stage and after the durability test.

### Example 15

A condensation product was synthesized by the same method as that of Example 1 except that HFE 7200 was not used as a solvent, and then a water-repellent antifouling coating material was prepared. Further, a water-repellent antifouling coating was obtained by the same procedure as that of Example 1. Table 1 shows the results. A slight amount of a development residue was generated because the synthesis was performed with no use of the fluorine-containing solvent. However, the water repellency was satisfactory.

### Example 16

A compound (ii) represented by the following formula was used in place of the compound (i).

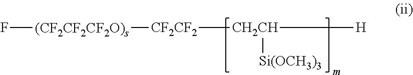

In the formula (ii), s represents an integer of from 20 to 30, and m represents an integer of from 1 to 3. In addition, the composition of the hydrolyzable silane compounds and the composition of the solvents were changed to those shown in Table 1. A condensation product was synthesized by the same method as that of Example 1 except for these changes, and then a water-repellent antifouling coating material was prepared. Further, a water-repellent antifouling coating was produced by the same procedure as that of Example 1. Table 1 shows the results. Owing to the large number of repeating units of the perfluoropolyether group, slight cloudiness was found in the solution of the condensation product, and a slightly depressed portion was generated on the surface of the water-repellent antifouling coating. However, no development residue was generated, and the water repellency was satisfactory.

### Example 17

A condensation product was synthesized by the same method as that of Example 1 except that the mixing amount of pure water was changed from 5.93 g to 4.94 g, and then a water-repellent antifouling coating material was prepared. Further, a water-repellent antifouling coating was produced by the same procedure as that of Example 1. Table 1 shows the results. As a result of the reduced amount of water at the time of the synthesis, the T0 amount and the T3 amount increased although the condensation degree did not change significantly. The water repellency of the water-repellent antifouling coating slightly lowered. However, no development residue was generated, and the smoothness was satisfactory.

### Example 18

A condensation product was synthesized by the same method as that of Example 1 except that the heating reflux time was shortened to 8 hours, and then a water-repellent antifouling coating material was prepared. Further, a water-repellent antifouling coating was produced by the same procedure as that of Example 1. Table 1 shows the results. The condensation degree lowered to 40%, and the water repellency of the water-repellent antifouling coating slightly lowered. However, no development residue was generated, and the smoothness was satisfactory.

### Example 19

A condensation product was synthesized by the same method as that of Example 1 except that the mixing amount of each hydrolyzable silane compound was changed to that shown in Table 1, and then a water-repellent antifouling coating material was prepared. Further, a water-repellent antifouling coating was produced by the same procedure as that of Example 1. Table 1 shows the results. The water repellency of the water-repellent antifouling coating slightly lowered. However, no development residue was generated, and the smoothness was satisfactory.

### Example 20

A condensation product was synthesized by the same method as that of Example 1 except that 0.001 mol/l hydrochloric acid was used in place of pure water, and then a water-repellent antifouling coating material was prepared. Further, a water-repellent antifouling coating was produced by the same procedure as that of Example 1. Table 1 shows the results. The water repellency of the water-repellent antifouling coating was satisfactory, no development residue was generated, and the smoothness was satisfactory.

### Comparative Example 1

A condensation product was synthesized by the same method as that of Example 1 except that C1 was not mixed and the composition was changed as shown in Table 1, and then a water-repellent antifouling coating material was prepared. Further, a water-repellent antifouling coating was produced by the same procedure as that of Example 1. Table 1 shows the results. A development residue was found, and a circular depressed portion was observed on the surface of the water-repellent antifouling coating.

### Comparative Example 2

A condensation product was synthesized by the same method as that of Example 1 except that GPTES was not mixed and the composition was changed as shown in Table 1, and then a water-repellent antifouling coating material was prepared. Further, a water-repellent antifouling coating was produced by the same procedure as that of Example 1. Table 1 shows the results. The water repellency of the water-repellent antifouling coating lowered, and water-repellent and antifouling performances were poor.

### Comparative Example 3

A condensation product was synthesized by the same method as that of Example 1 except that the compound (i), MTEOS, and HFE 7200 were not mixed and the composition was changed as shown in Table 1, and then a water-repellent antifouling coating material was prepared. Further, a water-repellent antifouling coating was produced by the same procedure as that of Example 1. Table 1 shows the results. The water repellency of the water-repellent antifouling coating lowered, and water-repellent and antifouling performances were poor.

TABLE 1

| | Condensation product | | | | | | | | | | | |
|---|---|---|---|---|---|---|---|---|---|---|---|---|
| | | | | | | Solvent | | | | | | |
| | Hydrolyzable silane compound | | | | | (mass %) | | | | | T0 | T3 |
| | (mol %. molar ratio) | | | | | | HFE | | Water amount | Condensation | amount | amount |
| | (a) | (b) | (c) | (d) | (c)/(a) | Ethanol | 7200 | Catalyst | (equivalent(s)) | degree (%) | (%) | (%) |
| Example 1 | (i) | GPTES | C1 | MTEOS | 24.75 | 80 | 20 | Pure | 1.2 | 70 | 3.5 | 36 |
| | 1 | 49.5 | 24.75 | 24.75 | | | | water | | | | |
| Example 2 | (i) | GPTES | Cl | MTEOS | 24.75 | 80 | 20 | Pure | 1.2 | 70 | 3.5 | 36 |
| | 1 | 49.5 | 24.75 | 24.75 | | | | water | | | | |
| Example 3 | (i) | GPTES | Cl | MTEOS | 24.75 | 80 | 20 | Pure | 1.2 | 70 | 3.5 | 36 |
| | 1 | 49.5 | 24.75 | 24.75 | | | | water | | | | |
| Example 4 | (i) | GPTES | Cl | PhTES | 24.75 | 80 | 20 | Pure | 1.2 | 64 | 2 | 24 |
| | 1 | 49.5 | 24.75 | 24.75 | | | | water | | | | |
| Example 5 | (i) | GPTES | C1 | MTEOS | 49.5 | 80 | 20 | Pure | 1.2 | 77 | 0 | 45 |
| | 1 | 24.75 | 49.5 | 24.75 | | | | water | | | | |
| Example 6 | (i) | GPTES | C1 | — | 49.5 | 80 | 20 | Pure | 1.2 | 70 | 2.5 | 40 |
| | 1 | 49.5 | 49.5 | — | | | | water | | | | |
| Example 7 | (i) | GPTES | C1 | — | 62.13 | 80 | 20 | Pure | 1.2 | 72 | 3 | 40 |
| | 0.8 | 49.5 | 49.7 | — | | | | water | | | | |
| Example 8 | (i) | GPTES | C1 | MTEOS | 3.5 | 80 | 20 | Pure | 1.2 | 60 | 0.4 | 14 |
| | 2 | 49.5 | 7 | 41.5 | | | | water | | | | |
| Example 9 | (i) | GPMDES | Cl | MTEOS | 24.75 | 80 | 20 | Pure | 1.2 | 70 | 3.5 | 36 |
| | 1 | 49.5 | 24.75 | 24.75 | | | | water | | | | |
| Example 10 | (i) | GPTES | Cl | MTEOS | 24.75 | 80 | 20 | 1% | 1.2 | 62 | 1.9 | 21 |
| | 1 | 49.5 | 24.75 | 24.75 | | | | Acetic | | | | |
| | | | | | | | | acid | | | | |
| Example 11 | (i) | GPTES | Cl | MTEOS | 24.75 | 80 | 20 | 0.4% | 1.2 | 58 | 1.4 | 15 |
| | 1 | 49.5 | 24.75 | 24.75 | | | | Formic | | | | |
| | | | | | | | | acid | | | | |
| Example 12 | (i) | GPTES | C6 | MTEOS | 7 | 80 | 20 | Pure | 1.2 | 66 | 0 | 18 |
| | 1 | 49.5 | 7 | 42.5 | | | | water | | | | |
| Example 13 | (i) | GPTES | C4 | MTEOS | 11 | 80 | 20 | Pure | 1.2 | 65 | 0 | 16 |
| | 1 | 49.5 | 11 | 38.5 | | | | water | | | | |
| Example 14 | (i) | GPTES | F5Ph | MTEOS | 11 | 80 | 20 | Pure | 1.2 | 58 | 4.2 | 11 |
| | 1 | 49.5 | 11 | 38.5 | | | | water | | | | |
| Example 15 | (i) | GPTES | Cl | MTEOS | 24.75 | 100 | 0 | Pure | 1.2 | 72 | 1 | 41 |
| | 1 | 49.5 | 24.75 | 24.75 | | | | water | | | | |
| Example 16 | (i) | GPTES | C1 | MTEOS | 49.5 | 50 | 50 | Pure | 1.2 | 73 | 1.4 | 37 |
| | 1 | 24.75 | 49.5 | 24.75 | | | | water | | | | |
| Example 17 | (i) | GPTES | C1 | MTEOS | 24.75 | 80 | 20 | Pure | 1.0 | 59 | 33 | 50 |
| | 1 | 49.5 | 24.75 | 24.75 | | | | water | | | | |
| Example 18 | (i) | GPTES | Cl | MTEOS | 24.75 | 80 | 20 | Pure | 1.2 | 40 | 19 | 8 |
| | 1 | 49.5 | 24.75 | 24.75 | | | | water | | | | |
| Example 19 | (i) | GPTES | C1 | MTEOS | 14.5 | 80 | 20 | Pure | 1.2 | 55 | 5.5 | 17 |
| | 1 | 70 | 14.5 | 14.5 | | | | water | | | | |
| Example 20 | (i) | GPTES | Cl | MTEOS | 24.75 | 80 | 20 | 0.001 | 1.2 | 60 | 1 | 15 |
| | 1 | 49.5 | 24.75 | 24.75 | | | | mol/l | | | | |
| | | | | | | | | Hydro- | | | | |
| | | | | | | | | chloric | | | | |
| | | | | | | | | acid | | | | |
| Comparative | (i) | GPTES | — | MTEOS | 0 | 80 | 20 | Pure | 1.2 | 51 | 9 | 13 |
| Example 1 | 1 | 49.5 | — | 49.5 | | | | water | | | | |
| Comparative | (i) | — | C1 | MTEOS | 49.5 | 80 | 20 | Pure | 1.2 | 75 | 0 | 47 |
| Example 2 | 1 | — | 49.5 | 49.5 | | | | water | | | | |
| Comparative | — | GPTES | Cl | — | — | 100 | 0 | Pure | 1.2 | 73 | 8 | 52 |
| Example 3 | — | 50 | 50 | — | | | | water | | | | |

| | Additive | | | | | | | |
|---|---|---|---|---|---|---|---|---|
| | Photoacid | | | Coating film | | Pure water | | |
| | generator | Resin | | external appearance | | contact angle (θr/°) | | |
| | (part(s) | (part(s) | | Development | Surface | | After | After |
| | by mass) | by mass) | Base material | residue | condition | Initial | immersion | abrasion |
| Example 1 | 0 | 0 | Substrate + | A | A | 98 | 90 | 92 |
| | | | Photopolymerizable | | | | | |
| | | | resin layer | | | | | |
| Example 2 | 0.4 | 0 | Substrate | A | A | 98 | 92 | 91 |
| Example 3 | 0.8 | 7 | Substrate | A | A | 100 | 92 | 93 |
| Example 4 | 0 | 0 | Substrate + | A | A | 95 | 90 | 90 |
| | | | Photopolymerizable | | | | | |
| | | | resin layer | | | | | |
| Example 5 | 0 | 0 | Substrate + | A | A | 89 | 70 | 78 |
| | | | Photopolymerizable | | | | | |
| | | | resin layer | | | | | |
| Example 6 | 0 | 0 | Substrate + | A | A | 92 | 80 | 83 |
| | | | Photopolymerizable | | | | | |
| | | | resin layer | | | | | |
| Example 7 | 0 | 0 | Substrate + | A | A | 90 | 76 | 80 |
| | | | Photopolymerizable | | | | | |
| | | | resin layer | | | | | |
| Example 8 | 0 | 0 | Substrate + | B | A | 96 | 92 | 90 |
| | | | Photopolymerizable | | | | | |
| | | | resin layer | | | | | |
| Example 9 | 0 | 0 | Substrate + | A | A | 98 | 90 | 92 |
| | | | Photopolymerizable | | | | | |
| | | | resin layer | | | | | |
| Example 10 | 0 | 0 | Substrate + | A | A | 99 | 92 | 94 |
| | | | Photopolymerizable | | | | | |
| | | | resin layer | | | | | |
| Example 11 | 0 | 0 | Substrate + | A | A | 100 | 94 | 94 |
| | | | Photopolymerizable | | | | | |
| | | | resin layer | | | | | |
| Example 12 | 0 | 0 | Substrate + | A | B | 96 | 90 | 89 |
| | | | Photopolymerizable | | | | | |
| | | | resin layer | | | | | |
| Example 13 | 0 | 0 | Substrate + | A | A | 95 | 84 | 87 |
| | | | Photopolymerizable | | | | | |
| | | | resin layer | | | | | |
| Example 14 | 0 | 0 | Substrate + | A | A | 98 | 91 | 92 |
| | | | Photopolymerizable | | | | | |
| | | | resin layer | | | | | |
| Example 15 | 0 | 0 | Substrate + | B | A | 97 | 89 | 90 |
| | | | Photopolymerizable | | | | | |
| | | | resin layer | | | | | |
| Example 16 | 0 | 0 | Substrate + | A | B | 101 | 92 | 94 |
| | | | Photopolymerizable | | | | | |
| | | | resin layer | | | | | |
| Example 17 | 0 | 0 | Substrate + | A | A | 88 | 70 | 80 |
| | | | Photopolymerizable | | | | | |
| | | | resin layer | | | | | |
| Example 18 | 0 | 0 | Substrate + | A | A | 90 | 74 | 82 |
| | | | Photopolymerizable | | | | | |
| | | | resin layer | | | | | |
| Example 19 | 0 | 0 | Substrate + | A | A | 90 | 75 | 82 |
| | | | Photopolymerizable | | | | | |
| | | | resin layer | | | | | |
| Example 20 | 0 | 0 | Substrate + | A | A | 97 | 88 | 90 |
| | | | Photopolymerizable | | | | | |
| | | | resin layer | | | | | |
| Comparative | 0 | 0 | Substrate + | C | C | 98 | 93 | 92 |
| Example 1 | | | Photopolymerizable | | | | | |
| | | | resin layer | | | | | |
| Comparative | 0 | 0 | Substrate + | A | A | 70 | 50 | 62 |
| Example 2 | | | Photopolymerizable | | | | | |
| | | | resin layer | | | | | |
| Comparative | 0 | 0 | Substrate + | A | A | 65 | 46 | 55 |
| Example 3 | | | Photopolymerizable | | | | | |
| | | | resin layer | | | | | |

According to embodiments of the present invention, it is possible to provide the water-repellent antifouling coating that has high water repellency and high durability against abrasion, and has a smooth surface.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese patent Application No. 2013-082769, filed Apr. 11, 2013, which is hereby incorporated by reference herein in its entirety.

What is claimed is:

1. A water-repellent antifouling coating material, comprising a condensation product obtained by condensing hydrolyzable silane compounds,
wherein the hydrolyzable silane compounds include:
(a) a hydrolyzable silane compound having a perfluoropolyether group;
(b) a hydrolyzable silane compound having an epoxy group; and
(c) a hydrolyzable silane compound having a fluorine-containing group other than perfluoropolyether groups.

2. A water-repellent antifouling coating material according to claim 1, wherein the hydrolyzable silane compound (a) having a perfluoropolyether group comprises at least one kind of compounds represented by the following formulae (1) to (4):
F-Rp-A-SiXₐY₃₋ₐ (1)
in the formula (1), Rp represents a perfluoropolyether group, A represents an organic group having from 1 to 12 carbon atoms, X represents a hydrolyzable substituent, Y represents a non-hydrolyzable substituent, and a represents an integer of from 1 to 3;
R₃₋ₐXₐSi-A-Rp-A-SiXₐY₃₋ₐ (2)
in the formula (2), R represents a non-hydrolyzable substituent and may be identical to or different from Y, and Rp, A, X, Y, and a have the same meanings as in the formula (1); 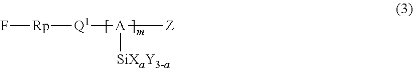
in the formula (3), Z represents a hydrogen atom or an alkyl group, Q¹ represents a divalent linking group, m represents an integer of from 1 to 4, and Rp, A, X, Y, and a have the same meanings as in the formula (1); and
F-Rp-Q²┘A-SiXₐY₃₋ₐ)ₙ (4)
in the formula (4), n represents 1 or 2, Q² represents a divalent linking group when n=1, and represents a trivalent linking group when n=2, and Rp, A, X, Y, and a have the same meanings as in the formula (1).

3. A water-repellent antifouling coating material according to claim 2, wherein Rp in the formulae (1) to (4) represents a group represented by the following formula (5): 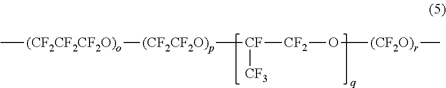
in the formula (5), o, p, q, and r each represent an integer of from 0 to 30, and at least one of o, p, q, and r represents an integer of 2 or more.

4. A water-repellent antifouling coating material according to claim 3, wherein, in the formula (5), a total of o, p, q, and r is an integer of from 3 to 10.

5. A water-repellent antifouling coating material according to claim 1, wherein the hydrolyzable silane compound (b) having an epoxy group comprises a compound represented by the following formula (6):
R_{c}—Si(R)_{b}X_{(3-b)} (6)
in the formula (6), R_{c} represents a non-hydrolyzable substituent having an epoxy group, R represents a non-hydrolyzable substituent, X represents a hydrolyzable substituent, and b represents an integer of from 0 to 2.

6. A water-repellent antifouling coating material according to claim 1, wherein the hydrolyzable silane compound (c) having a fluorine-containing group other than perfluoropolyether groups comprises a compound represented by the following formula (7):
(R_{f})ₐ—Si(R)_{b}X_{(4-a-b)} (7)
in the formula (7), R_{f} represents an alkyl group or aryl group having 1 or more fluorine atoms, R represents a non-hydrolyzable substituent, X represents a hydrolyzable substituent, a represents an integer of 1 or 2, b represents an integer of from 0 to 2, and a+b is an integer of from 1 to 3.

7. A water-repellent antifouling coating material according to claim 6, wherein R_{f} in the formula (7) represents an alkyl group or aryl group having from 1 to 10 fluorine atoms.

8. A water-repellent antifouling coating material according to claim 7, wherein R_{f} in the formula (7) represents a group selected from the group consisting of a 3,3,3-trifluoropropyl group, a pentafluorophenyl group, a perfluorobutyl group, and a trifluoromethyl group.

9. A water-repellent antifouling coating material according to claim 1, wherein the hydrolyzable silane compounds further include a hydrolyzable silane compound (d) having an alkyl group or an aryl group represented by the following formula (8):
(R_{d})ₐ—SiX₍₄₋ₐ₎ (8)
in the formula (8), R_{d} represents an alkyl group or an aryl group, X represents a hydrolyzable substituent, and a represents an integer of from 1 to 3; and when a represents 2 or 3 and multiple R_{d}'s are present, R_{d}'s may be identical to or different from each other.

10. A water-repellent antifouling coating material according to claim 9, wherein the hydrolyzable silane compound (d) having an alkyl group or an aryl group represented by the formula (8) has at least one of a methyl group and a phenyl group as R_{d}.

11. A water-repellent antifouling coating material according to claim 1, wherein a molar ratio (a):(c) of the hydrolyzable silane compound (a) having a perfluoropolyether group to the hydrolyzable silane compound (c) having a fluorine-containing group other than perfluoropolyether groups is from 1:4 to 1:50.

12. A water-repellent antifouling coating material according to claim 1, wherein the condensation product is obtained by heating the hydrolyzable silane compounds in a mixed liquid of a fluorine-free organic solvent and a fluorine-containing solvent.

13. A water-repellent antifouling coating material according to claim 12, wherein the mixed liquid of the fluorine-free organic solvent and the fluorine-containing solvent comprises a mixed liquid of an alcohol and a hydrofluoroether.

14. A water-repellent antifouling coating material according to claim 1, wherein the condensation product is obtained by subjecting the hydrolyzable silane compounds to a reaction using an acid as a catalyst in the presence of an organic solvent and water.

15. A water-repellent antifouling coating material according to claim 14, wherein the acid comprises a carboxylic acid.

16. A water-repellent antifouling coating material according to claim 1, wherein the condensation product has a condensation degree of 40% or more and 90% or less.

17. A water-repellent antifouling coating material according to claim 1, wherein in the condensation product, a proportion of an Si atom bonded to three hydrolyzable silane compounds via oxygen with respect to all Si atoms is 50% or less.

18. A water-repellent antifouling coating material according to claim 1, wherein a ratio of a number of moles of the hydrolyzable silane compound (b) having an epoxy group to a total number of moles of the hydrolyzable silane compounds is from 30 to 70 mol %.

19. A water-repellent antifouling coating material according to claim 1, wherein a ratio of a number of moles of the hydrolyzable silane compound (c) having a fluorine-containing group other than perfluoropolyether groups to a total number of moles of the hydrolyzable silane compounds is from 1 to 50 mol %.

20. A water-repellent antifouling coating material according to claim 1, further comprising an epoxy compound other than hydrolyzable silane compounds.
